(19) United States
(12) Patent Application Publication
(10) Pub. No.: US 2008/0122972 A1
(43) Pub. Date: May 29, 2008

(54) IMAGE TRANSMISSION INTERFACE

(75) Inventors: Nan-Jiun Yin, Hsinchu (TW); Hsin-Chi Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/864,988

(22) Filed: Sep. 29, 2007

(30) Foreign Application Priority Data
Nov. 29, 2006 (TW) 95144167

(51) Int. Cl. H04N 7/01

(52) U.S. Cl. 348/441

(57) ABSTRACT

An image transmission interface for transmitting image signals of various image formats is provided. The image transmission interface replaces the connectors of various interfaces in an electronic device, thereby reducing the number of connectors of the electronic device and reducing the manufacturing cost.

### CROSS-REFERENCE TO RELATED APPLICATION

This application claims the priority benefit of Taiwan application serial no. 95144167, filed Nov. 29, 2006. All disclosure of the Taiwan application is incorporated herein by reference.

### BACKGROUND OF THE INVENTION

1. Field of the Invention

The present invention relates to an image transmission interface, and more particularly, relates to an image transmission interface for transmitting image signals of various image formats.

2. Description of Related Art

In video broadcasting systems, different transmission interfaces have different signal formats and connectors. The more the image formats are supported by an electronic device, the more the connectors are disposed, which results in a large volume of electronic device and an increase of cost.

A conventional transmission interface for transmitting image signals is shown in FIG. 1. FIG. 1 is a schematic view of connectors of a conventional transmission interface. Among composite signals, a Composite Video Baseband Signal (CVBS) is transmitted through a Radio Corporation of American (RAC) pin (as shown in FIG. 1(a)), a Super-Video (S-Video) signal is transmitted through a connector of 4 P MiniDin (as shown in FIG. 1(b)), a component signal is transmitted through component terminals (as shown in FIG. 1(c)), and a SCART signal is transmitted through a SCART connector (as shown in FIG. 1(d)). A digital image signal is transmitted through a digital visual interface (DVI) connector (as shown in FIG. 1(f)) or High-Definition Multimedia Interface (HDMI) connector (as shown in FIG. 1(e)). The names of pins of the HDMI connector and DVI connector are respectively marked in FIG. 1(e) and FIG. 1(f). A conventional DVI connector is classified into three types, namely digital type, analog type, and digital-analog type, which are easily deduced by those skilled in the art, and will not be described herein.

However, with the diversification of image formats, conventional electronic device such as projector and digital television are always provided with connectors of various different interfaces so as to make the electronic device more convenient in use, thereby resulting in a large volume of the electronic device and an increase of cost.

### SUMMARY OF THE INVENTION

The present invention is directed to providing an image transmission interface, which is capable of transmitting image signals of various image formats through a DVI by integrating the functions of various transmission interfaces into one visual interface, thereby reducing the number of connectors required by the electronic device and reducing the manufacturing cost.

The present invention is also directed to providing an image transmission interface, which transmits and receives image signals of various image formats through a DVI by integrating the transmission functions of various connectors into the connectors of the DVI, thereby reducing the number of connectors required by the electronic device and reducing the manufacturing cost.

In order to achieve the above and other aspects, the present invention provides an image transmission interface for transmitting image signals of various image formats. The image transmission interface comprises a DVI connector and a decoding unit. The DVI connector is used for receiving a first image signal, and the image format of the first image signal is one of the image formats. The decoding unit is coupled to the DVI connector, and is used for decoding the received first image signal.

In another embodiment of the present invention, the first image signal is an S-Video signal, the DVI uses a pin Analog_R to transmit a chrominance signal of the S-Video signal, a pin Analog_G to transmit a luminance signal of the S-Video signal, and a ground pin Analog_Gnd to receive a ground signal of the S-Video signal.

In another embodiment of the present invention, the first image signal is a composite signal, and the DVI connector uses a pin Analog_R, Analog_G, or Analog_B to transmit a CVBS signal of the composite signal.

In another embodiment of the present invention, the first image signal is a component signal. The DVI connector uses a pin Analog_R to transmit a Pr component signal of the component signal, a pin Analog_B to transmit a Pb component signal of the component signal, and a pin Analog_G to transmit a luminance signal of the component signal.

In another embodiment of the present invention, the first image signal is a SCART signal, the DVI connector uses a pin Analog_R to transmit a red signal of the SCART signal, a pin Analog_G to transmit a green signal of the SCART signal, a pin Analog_B to transmit a blue signal of the SCART signal, and a pin Analog_Hysnc to transmit a CVBS signal of the SCART signal.

In another embodiment of the present invention, the image transmission interface comprises an adaptor coupled to the DVI connector such that the DVI connector is adapted to receive the first image signal. The decoding unit further comprises a register coupled to the DVI for storing the first image signal.

In the present invention, the DVI is used to transmit and receive image signals of various image formats, and integrates the transmission functions of various connectors into the connector of the DVI, so as to form a new image transmission interface, thereby reducing the number of connectors required by the electronic device and reducing the manufacturing cost.

In order to make the aforementioned and other aspects, features and advantages of the present invention comprehensible, preferred embodiments accompanied with figures are described in detail below.

Other objectives, features and advantages of the present invention will be further understood from the farther technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of connectors according to a conventional transmission interface.

FIG. 2A is a block diagram of an image transmission interface according to an embodiment of the present invention.

FIG. 2B is a flow chart of the image decoding according to FIG. 2A.

FIG. 3 is a schematic view illustrating pin correspondence of a DVI connector and an S_Video connector according to an embodiment of the present invention.

FIG. 4 is a schematic view illustrating pin correspondence of the DVI connector and a composite signal connector according to another embodiment of the present invention.

FIG. 5 is a schematic view illustrating pin correspondence of the DVI connector and a component signal connector according to still another embodiment of the present invention.

FIG. 6 is a schematic view illustrating pin correspondence of the DVI connector and an SCART connector according to yet another embodiment of the present invention.

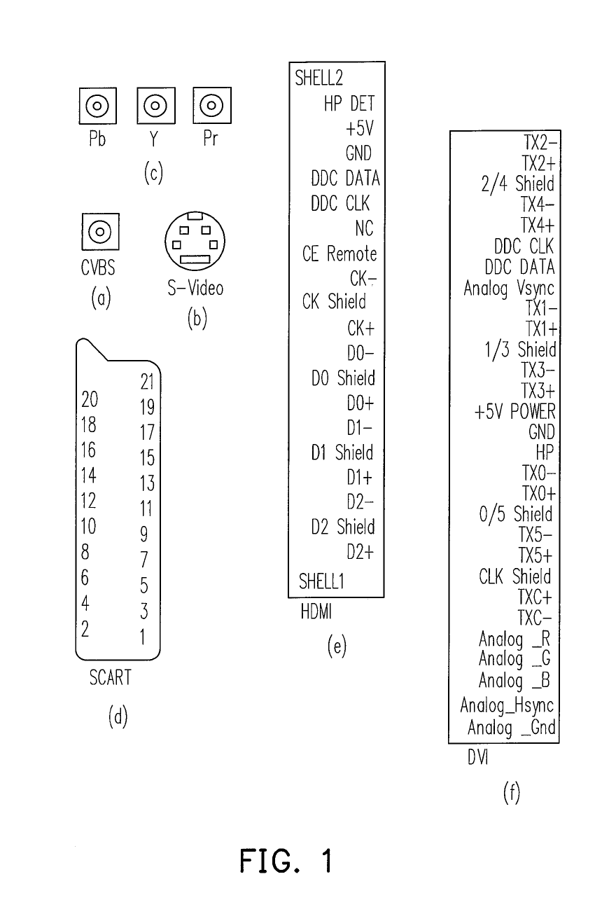

### DESCRIPTION OF EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings

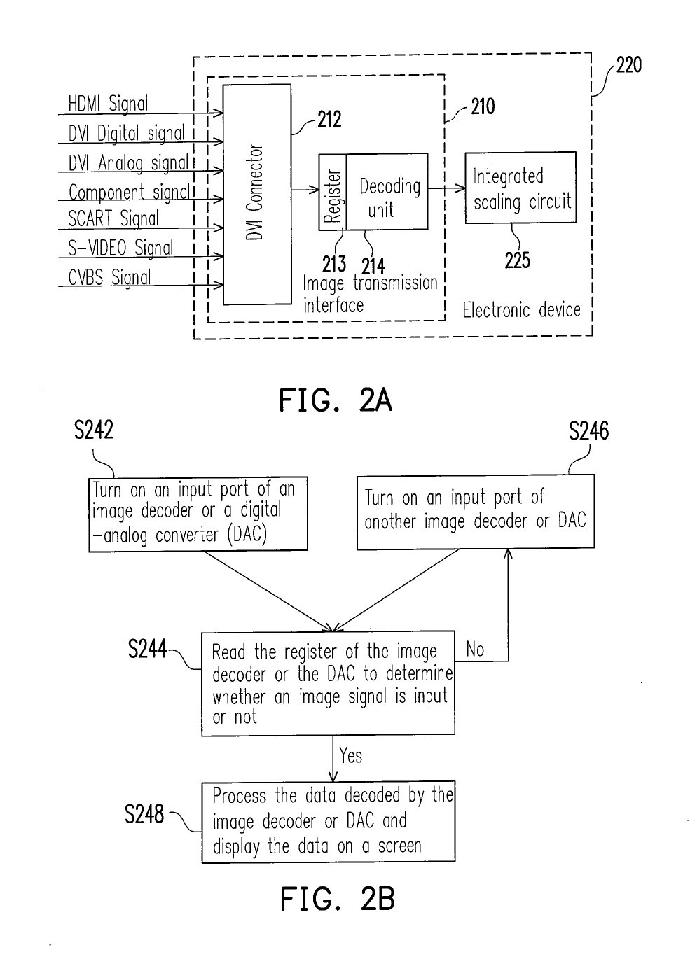

FIG. 2A is a block diagram of an image transmission interface according to an embodiment of the present invention. Referring to FIG. 2A, the image transmission interface 210 is adapted for transmitting image signals of various image formats. The image transmission interface 210 is disposed in an electronic device 220. The electronic device 220, such as a projector or a digital television, supports image signals of various image formats (such as RGB, Y/Pb/Pr or Y/C). The image transmission interface 210 includes a DVI connector 212 and a decoding unit 214. The DVI connector 212 is used to receive a first image signal, and the image format of the first image signal is one of the various image formats. The decoding unit 214 is coupled to the DVI connector 212, for decoding the image signal received by the DVI connector 212 and outputting the signal to an integrated scaling circuit 225. The electronic device 220 displays the image content received by the DVI connector 212 according to the output of the decoding unit 214. The decoding unit 214 (e.g., image decoding chip) further includes a register 213 for registering the image signal received by the DVI connector 212.

In this embodiment, the electronic device 220 receives image signals of various image formats through the DVI connector 212 (e.g., DVI-D, DVI-A or DVI-I) of the image transmission interface 210, in which the image signals include, for example, a HDMI signal, a DVI digital signal, a DVI analog signal, a component signal, an SCART signal, an S_Video signal, or a CVBS signal (i.e., a composite signal). Since the state of the image signal is stored in the register 213 of the decoding unit 214, by the use of the register 213, the decoding unit 214 determines whether the image signal has been received or not. If the image signal is stored in the register 213, the received image signal is read and decoded, and then output to the integrated scaling circuit 225, such that the electronic device 220 displays the content of the image signal. In another embodiment of the present invention, the register 213 and the decoding unit 214 are disposed separately, for registering data and decoding image signals respectively.

As different types of image signals require for different decoding manners, image decoders adapted for various image formats are disposed in the decoding unit 214, so as to decode different image signals with a corresponding image decoder until the decoding of the image signals is finished. FIG. 2B is a flow chart of the image decoding according to FIG. 2A. First, in step S242, an input port of an image decoder or a digital-analog converter (DAC) in the decoding unit 214 is turned on. Next, in step S244, the register of the image decoder or the DAC is read to determine whether an image signal is input or not. If no, step S246 is proceeded, and an input port of another image decoder or DAC in the decoding unit 214 is turned on, and the determination of step S244 is performed again. If yes, step S248 is proceeded, and the data decoded by the image decoder or DAC is processed and displayed on a screen (not shown) of the electronic device 220.

In this embodiment, the DVI connector 212 transmits image data to adaptors of different interfaces through different adaptors or an adaptor supporting different interfaces. During the transmission, the correspondence between the transmission pins of the DVI connector 212 and image signals of different image formats is illustrated as follows.

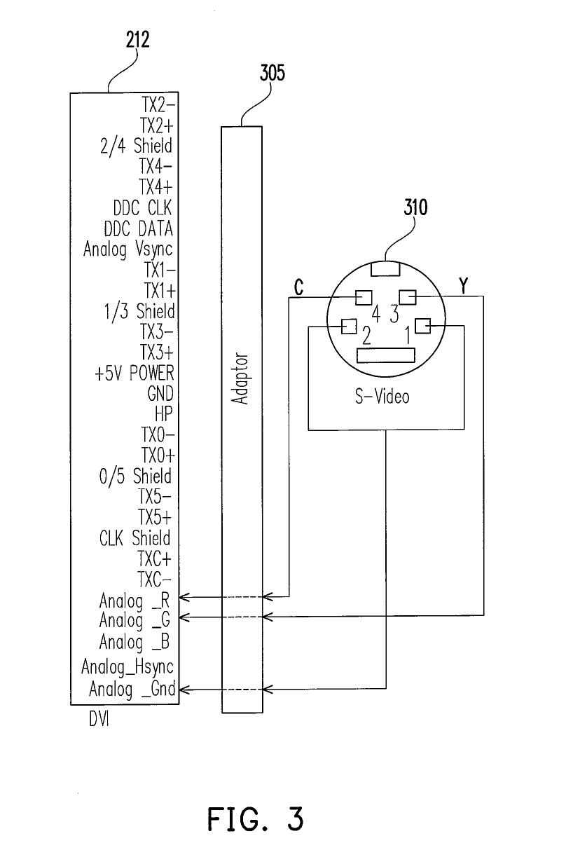

FIG. 3 is a schematic view illustrating pin correspondence of the DVI connector and the S_Video connector according to an embodiment of the present invention. Referring to FIG. 3 and FIG. 2A together, an adaptor 305 is coupled between the DVI connector 212 and an S_Video connector 310 so as to convert between different connector interfaces, such that the DVI connector 212 is capable of receiving the image signal from the S_Video connector 310. The S_Video signal received by the S_Video connector 310 includes a chrominance (C) signal and a luminance (Y) signal, which are respectively transmitted by a pin 4 and a pin 3 of the S_Video connector 310. In the present invention, the pins Analog_R and Analog_G in the DVI connector 212 are used to transmit the chrominance signal and the luminance signal. A ground pin Analog_Gnd is connected with a ground signal of pins 1, 2 of the S_Video connector 310, so as to establish a ground level between the electronic device 220 and a signal source. As such, the DVI connector 212 is capable of transmitting the S_Video signal.

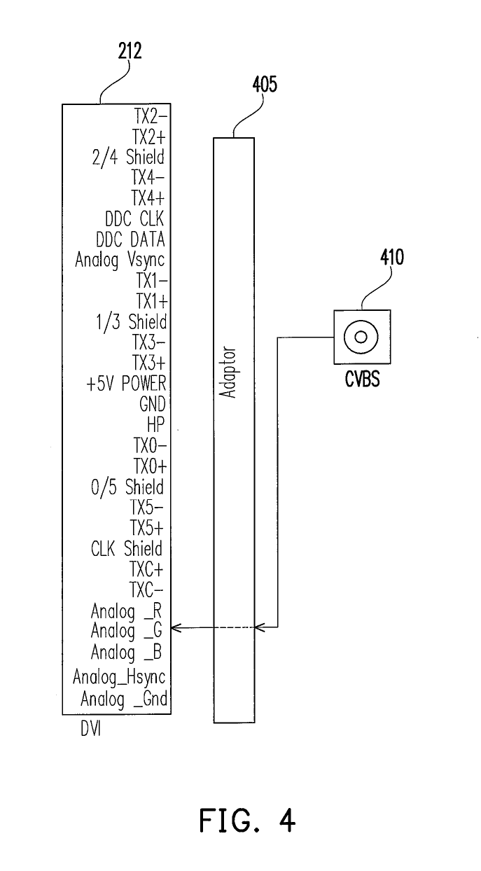

FIG. 4 is a schematic view illustrating pin correspondence of the DVI connector and the composite signal connector according to another embodiment of the present invention. An adaptor 405 is coupled between the DVI connector 212 and a RCA connector 410 so as to convert between different connector interfaces, such that the DVI connector 212 can receive the image signal from the RCA connector 410. The composite signal mainly includes a CVBS signal, which is transmitted by a single RCA connector 410. In this embodiment, the CVBS signal can be transmitted through one of the pins Analog_R, Analog_G or Analog_B of the DVI connector 212, and the transmission pin thereof can be determined by designers as required, without influencing the efficacy of this embodiment.

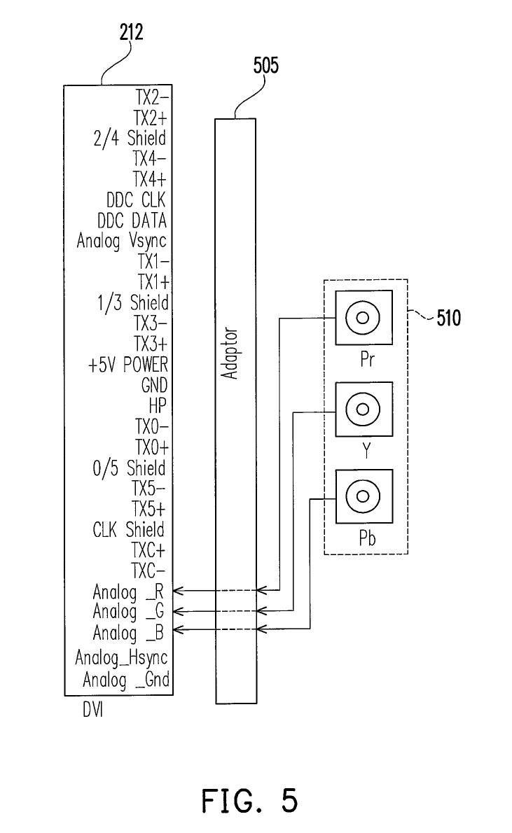

FIG. 5 is a schematic view illustrating pin correspondence of the DVI connector and the component signal connector according to still another embodiment of the present invention. An adaptor 505 is coupled between the DVI connector 212 and a component signal connector 510 so as to convert between different connector interfaces, such that the DVI connector 212 may receive the image signal from the component signal connector 510. If the image signal is a component signal including a luminance (Y) signal and chrominance (Pb, Pr) signals, the DVI connector 212 uses pins Analog_G, Analog_B, Analog_R to transmit the luminance (Y) signal and the chrominance (Pb, Pr) signals respectively. The correspondence between the pins of the DVI connector 212 and the component signal is adjusted according to the requirements of users, without influencing the efficacy of this embodiment as long as the transmitters are corresponding to the receivers.

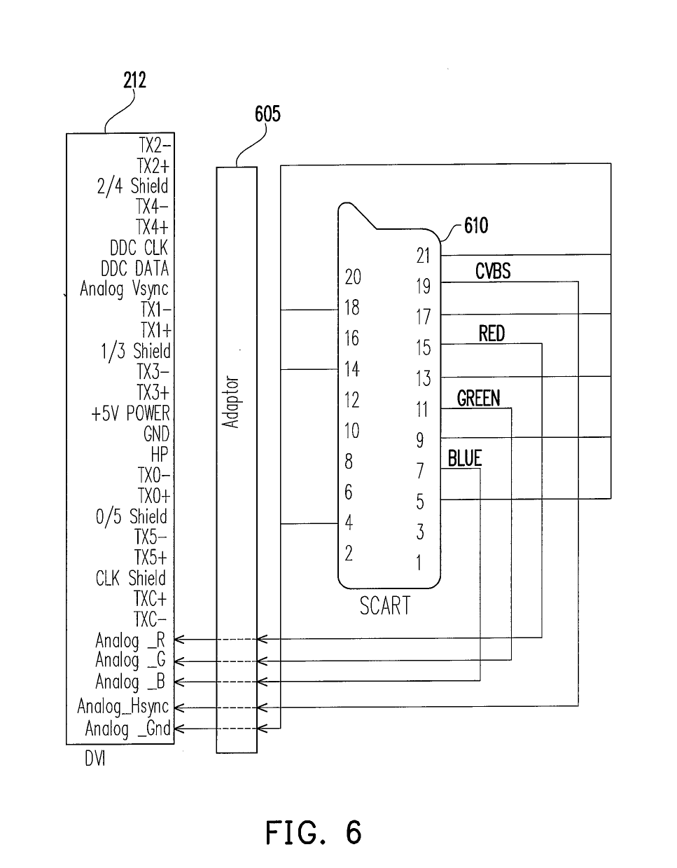

FIG. 6 is a schematic view illustrating pin correspondence of the DVI connector and the SCART connector according to yet another embodiment of the present invention. An adaptor 605 is coupled between the DVI connector 212 and a SCART connector 610 so as to convert between different connector interfaces, such that the DVI connector 212 can receive the image signal from the SCART connector 610. When the image signal is an SCART signal, the DVI connector 212 uses pins Analog_R, Analog_G, Analog_B to transmit RGB signals (red signal, green signal, and blue signal) in the SCART signal, i.e., the pins Analog_R, Analog_G, Analog_B are connected to the pins 7, 11, 15 in the SCART connector 610, and uses a pin Analog_Hsync to transmit the CVBS signal in the SCART signal, i.e., the pin Analog_Hsync is connected to a pin 19 in the SCART connector 610. In addition, a ground level is established between the signal source and the electronic device 220 through the pin Analog_Gnd of the DVI connector 212, i.e., the pin Analog_Gnd is connected to the pins 4, 5, 9, 13, 14, 17, 18 and 21 of the SCART connector 610.

In view of the above embodiments of FIG. 3 to FIG. 6, the DVI connector 212 transmits image signals with connectors of different interfaces (the S_Video connector 310, the RCA pin 410, the component signal connector 510, and the SCART connector 610) through different adaptors. In another embodiment of the present invention, the adaptor is designed as a one-to-many format, and one end of the adaptor is connected to the DVI connector, and the other end is connected to various connector interfaces mentioned above. Therefore, with the pins Analog_R, Analog_G, Analog_B, Analog_Hsync, and Analog_Gnd of the DVI connector 212, the present invention realizes the transmission effect of various connectors.

With the technical means of the present invention, the electronic device transmits image signals of various types only by using the DVI connector 212, thereby achieving the effect of integrating various connectors. Similarly, the DVI connector 212 also realizes the transmission effect of the HDMI connector, which can be easily deduced by those of ordinary skill in the art with reference to the disclosure of the present invention, and is not described herein. In practical application, a signal DVI connector is used to replace various connectors only by adjusting the types of image signals transmitted by different pins correspondingly and using a decoding unit, thus the manufacturing cost of the electronic device is reduced.

In the present invention, the image transmission manners of different interfaces are integrated into a single DVI connector, and the DVI interface is used to transmit and receive image signals of various image formats. The present invention integrates the transmission functions of various connectors into the DVI connector, so as to form a new image transmission interface, thereby reducing the number of connectors required by the electronic device and reducing the manufacturing cost.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An image transmission interface, for transmitting image signals of various image formats, the image transmission interface comprising:
a digital visual interface (DVI) connector, for receiving a first image signal, the image format of the first image signal being one of the image formats; and
a decoding unit, coupled to the DVI connector and adapted for decoding the first image signal.

2. The image transmission interface as claimed in claim 1, wherein the first image signal is an S-Video signal, and the DVI connector comprises:
a first pin, for transmitting a chrominance signal of the S-Video signal;
a second pin, for transmitting a luminance signal of the S-Video signal; and
a ground pin, for receiving a ground signal of the S-Video signal.

3. The image transmission interface as claimed in claim 2, wherein the first pin is Analog_R, the second pin is Analog_G, and the ground pin is Analog_Gnd.

4. The image transmission interface as claimed in claim 1, wherein the first image signal is a composite signal, the DVI connector comprises a first pin for transmitting a CVBS signal of the composite signal.

5. The image transmission interface as claimed in claim 4, wherein the first pin is Analog_R, Analog_G, or Analog_B.

6. The image transmission interface as claimed in claim 1, wherein the first image signal is a component signal, and the DVI connector comprises:
a first pin, for transmitting a Pr component signal of the component signal;
a second pin, for transmitting a Pb component signal of the component signal; and
a third pin, for transmitting a luminance signal of the component signal.

7. The image transmission interface as claimed in claim 6, wherein the first pin is Analog_R, the second pin is Analog_B, and the third pin is Analog_G.

8. The image transmission interface as claimed in claim 1, wherein the first image signal is a SCART signal, and the DVI connector comprises:
a first pin, for transmitting a red signal of the SCART signal;
a second pin, for transmitting a green signal of the SCART signal;
a third pin, for transmitting a blue signal of the SCART signal; and
a fourth pin, for transmitting a CVBS signal of the SCART signal.

9. The image transmission interface as claimed in claim 8, wherein the first pin is Analog_R, the second pin is Analog_G, the third pin is Analog_B, and the fourth pin is Analog_Hysnc.

10. The image transmission interface as claimed in claim 1, further comprising:
an adaptor, coupled to the DVI connector whereby the DVI connector is adapted to receive the first image signal.

11. The image transmission interface as claimed in claim 1, wherein the decoding unit comprises:
a register, for storing the first image signal.
